(19) United States
(12) Patent Application Publication
(10) Pub. No.: US 2013/0117284 A1
(43) Pub. Date: May 9, 2013

(54) USE OF SOCIAL RANKS TO FIND PROVIDERS OF RELEVANT USER-GENERATED CONTENT

(71) Applicants: Adam Roozen, Mankato, MN (US); Michael Braun, Lakeville, MN (US)

(72) Inventors: Adam Roozen, Mankato, MN (US); Michael Braun, Lakeville, MN (US)

(73) Assignee: ECHIDNA, INC., Minneapolis, MN (US)

(21) Appl. No.: 13/811,372

(22) PCT Filed: Jul. 19, 2011
(86) PCT No.: PCT/US2011/044566

§ 371 Date: Jan. 21, 2013

Related U.S. Application Data
(60) Provisional application No. 61/365,626, filed on Jul. 19, 2010.

(51) Int. Cl. G06F 17/30

(52) U.S. Cl. CPC G06F 17/30861
USPC 707/748

(57) ABSTRACT

A social rank service is provided to a consumer. The social rank service enables the consumer to compare social ranks of contributors who generate and distribute user-generated content regarding a topic. The social ranks of the contributors are based on the volume of content on the topic generated by the contributors. The social ranks of the contributors are also based on the credibility of the contributors. In this way, the consumer may be able to identify contributors who regularly generate credible content on the topic.

### BACKGROUND

There are millions of sources of user-generated content on today's Internet. For instance, there are millions of Twitter accounts, social networking status update streams, blogs, YouTube channels, and other sources of user-generated content. With all of these sources of user-generated content, it can be difficult for a user to find relevant and credible sources of user-generated content regarding particular topics. For example, it can be difficult for a user to find sources of high-quality user-generated content regarding the user's hobbies or interests, such as rock climbing.

### SUMMARY

A social rank service is provided to a consumer. The social rank service enables the consumer to compare social ranks of contributors who generate and distribute user-generated content regarding a topic. The social ranks of the contributors are based on the volume of content on the topic generated by the contributors. The social ranks of the contributors are also based on the credibility of the contributors. In this way, the consumer may be able to identify contributors who regularly generate credible quality content regarding the topic.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system.

FIG. 2 is a block diagram illustrating example details of an aggregation server.

FIG. 3 is a flowchart illustrating an example operation performed when a contributor creates a profile.

FIG. 3A is a flowchart illustrating an alternative example operation performed when a contributor creates a profile.

FIG. 4 is a flowchart illustrating an example operation performed when a consumer is looking for sources of user-generated content.

FIG. 4A is a flowchart illustrating an alternative example operation performed when a consumer is looking for sources of user-generated content.

FIG. 5 is a screen illustration of an example topic selection interface.

FIG. 6 is a screen illustration of an example chart interface.

FIG. 7 is a screen illustration of an example contributor ranking interface.

FIG. 8 is a screen illustration of an example contributor detail interface.

FIG. 9 is a block diagram illustrating an example computing device.

FIG. 10 is a flowchart illustrating an example operation to display dynamic topic channels.

### DETAILED DESCRIPTION

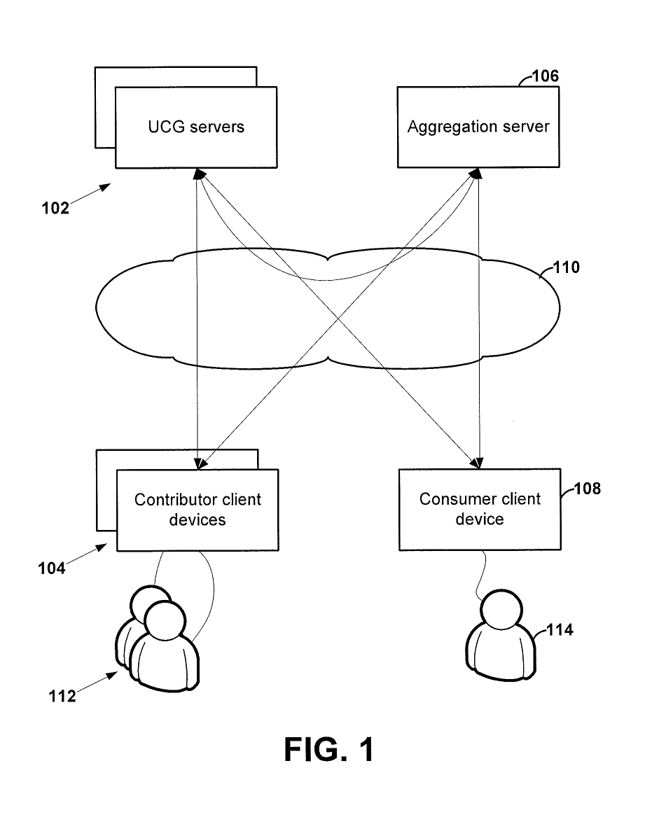

FIG. 1 is a block diagram illustrating an example system 100. As illustrated in the example of FIG. 1, the system 100 comprises a set of User-Generated Content (UGC) servers 102, a set of contributor client devices 104, an aggregation server 106, a consumer client device 108, and a network 110. The UGC servers 102, the contributor client devices 104, the aggregation server 106, and the consumer client device 108 are computing systems.

The network 110 facilitates communication among the UGC servers 102, the contributor client devices 104, the aggregation server 106, and the consumer client device 108. In various embodiments, the network 110 can be various types of networks. For example, the network 110 can be a wide area network, such as the Internet. In another example, the network 110 can be a local area network, a virtual private network, or another type of communications network.

The UGC servers 102 are systems of computing devices that provide UGC services. The UGC services store and distribute user-generated content. The UGC services can include microblogging services, such as Twitter, Tumblr, Plurk, identi.ca, Emote.in, Beeing, Jaiku, and so on. Furthermore, the UGC services can include social networking services, such as Facebook, MySpace, Orkut, Friendster, LinkedIn, Qzone, and so on. Furthermore, the UGC services can include media sharing sites, such as YouTube, Flickr, Picasa, and so on. Furthermore, the services provided by the UGC servers 102 can include blogging services, such as Blogger, LiveJournal, Google Blogs, and so on.

As illustrated in the example of FIG. 1, the system 100 also comprises a set of contributors 112. The contributors 112 are people who use the UGC services provided by the UGC servers 102 to generate and distribute content. The contributors 112 use the contributor client devices 104 to access the UGC servers 102. The contributor client devices 104 can be a variety of different types of computing devices. For example, the contributor client devices 104 can be desktop computers, workstation computers, video game consoles, television set top boxes, network-connected televisions, or other types of computing devices. Furthermore, the contributor client devices 104 can be mobile computing devices, such as smartphones, tablet computers, personal media players, in-vehicle computing systems, laptop computers, netbook computers, or other types of computing devices designed to be mobile.

To use the UGC services, the contributors 112 establish UGC accounts with the UGC services. For example, the contributors 112 can establish Facebook profiles with the Facebook service. After establishing UGC accounts with the UGC services, the contributors 112 publish content through the UGC accounts. For example, the contributors 112 can use their Twitter accounts to publish tweets.

Some of the contributors 112 generate content using multiple ones of the UGC services provided by the UGC servers 102. For example, one of the contributors 112 can generate tweets using Twitter and can generate status updates using Facebook. Furthermore, some of the contributors 112 can generate content using multiple profiles on the same UGC service. For example, one of the contributors 112 can generate tweets about professional matters using one Twitter account and can generate tweets about personal matters using another Twitter account. In another example, one of the contributors 112 can use one of the UGC services to manage two or more separate blogs.

The aggregation server 106 is a system of one or more computing devices that provides a social rank service. In some embodiments, the entity that provides the social rank service is different than the entities that provide the UGC services. As described in detail elsewhere in this document, the social rank service allows the contributors 112 to create profiles. A contributor's profile lists UGC accounts that the contributor uses to generate and distribute content. For example, a given contributor's profile can list a Facebook account, two blog accounts, and a Twitter account.

In addition, the system 100 comprises a consumer 114. The consumer 114 is a person who wants to receive user-generated content regarding a particular topic. For example, the consumer 114 may want to receive user-generated content regarding NASCAR, grilling, or bass fishing. However, there are millions of people on the Internet generating content. Consequently, the task of finding people who generate content on the particular topic can be difficult.

To ease the process of finding people who generate content on the particular topic, the consumer 114 uses the consumer client device 108 to access the social rank service provided by the aggregation server 106. The consumer client device 108 can be a variety of different types of computing devices. For example, the consumer client device 108 can be a desktop computer, a workstation computer, a video game console, a television set top box, a network-connected television, or another type of computing device. Furthermore, the consumer client devices 108 can be a mobile computing device, such as a smartphone, a tablet computer, a personal media player, an in-vehicle computing system, a laptop computer, a netbook computer, or another type of computing device designed to be mobile.

When the consumer 114 accesses the social rank service, the social rank service displays a topic selection interface to the consumer 114. The topic selection interface allows the consumer 114 to select a topic of interest to the consumer 114. After the consumer identifies a topic, the social rank service displays an interface that enables the consumer 114 to compare the social ranks of the contributors 112 with regard to the topic. The social rank of a contributor with regard to the topic is based on both contributor's volume score and the contributor's credibility score. The contributor's volume score is based on the amount of content generated by the contributor using a UGC account associated with the topic. The contributor's credibility score is a measure of how much attention consumers give to content generated by the contributor. For example, the contributor's credibility score can based on a total number of people who consume content on any of the UGC accounts claimed by the given contributor, numbers of comments received from consumers on content generated by the contributor, ratings by consumers of content generated by the contributor, ratings by the consumer of the contributor, numbers of times consumers have viewed content generated by the contributor, and/or other ways of determining amounts of attention that consumers give to content generated by the consumer.

In general, contributors who consistently generate a desirable amount of content regarding the topic and/or have greater credibility have higher social ranks than contributors who generate less content regarding the topic and/or have less credibility. For example, a contributor who only generates content once a month and who has little credibility has a lower social rank than a contributor who generates content once a day and who has a great deal of credibility. In another example, a first contributor generates content once a day, but has little credibility. In this example, a second contributor generates content once a week, but has a great deal of credibility. In this example, the second contributor may have a higher social rank.

By comparing the social ranks of the contributors 112, the consumer 114 is able to identify a subset of the contributors 112 that would provide the best content to the consumer 114. The social rank service enables the consumer 114 to subscribe to UGC accounts associated with the identified contributors. For example, the consumer 114 can use the social rank service to subscribe to a Twitter feed associated with one of the identified contributors. In another example, the consumer 114 can use the social rank service to become a friend or fan of a Facebook account used by the selected contributor.

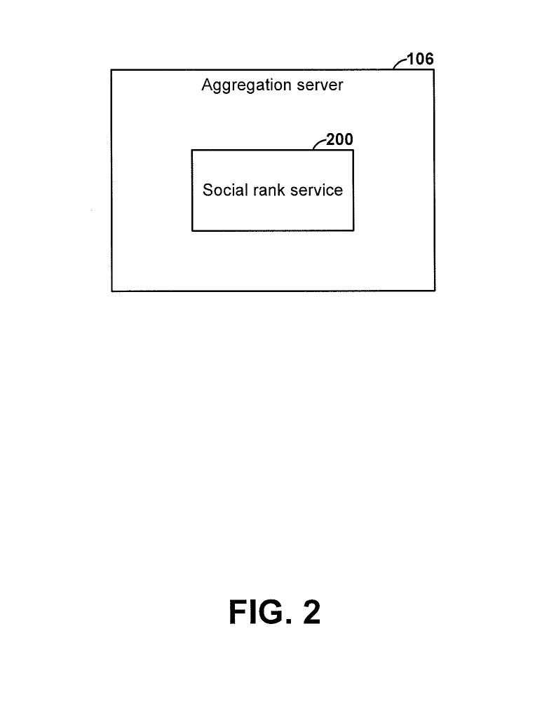

FIG. 2 is a block diagram illustrating example details of the aggregation server 106. As illustrated in the example of FIG. 2, the aggregation server 106 provides a social rank service 200. In some embodiments, the aggregation server 106 provides the social rank service 200 when a processing system of the aggregation server 106 executes computer-executable instructions that cause the aggregation server 106 to provide these services. The computer-executable instructions can be stored in one or more computer readable media internal to or external to the aggregation server 106.

As described above, the social rank service 200 enables the contributors 112 to create profiles and enables the consumer 114 to compare the social ranks of the contributors 112 with regard to particular topics. The contributors 112 and the consumer 114 are users of the social rank service 200. To enable the contributors 112 to create profiles and to enable the consumer 114 to compare the social ranks of the contributors 112, the social rank service 200 provides user interfaces to these users of the social rank service 200. The user interfaces allow the social rank service 200 to present data to users and also allow the social rank service 200 to receive data from the users. In various embodiments, the social rank service 200 provides the user interfaces to the users in various ways. For example, the social rank service 200 can send user interface data via the network 110 to client devices used by the users (e.g., the contributor client devices 104 and the consumer client device 108). The user interface data represents the user interfaces. The client devices process this user interface data to display the user interfaces. In various embodiments, the user interface data can have various types. For example, the user interface data can be HTML data, XML data, Adobe Flash data, ActiveX control data, Java applet data, or other types of data.

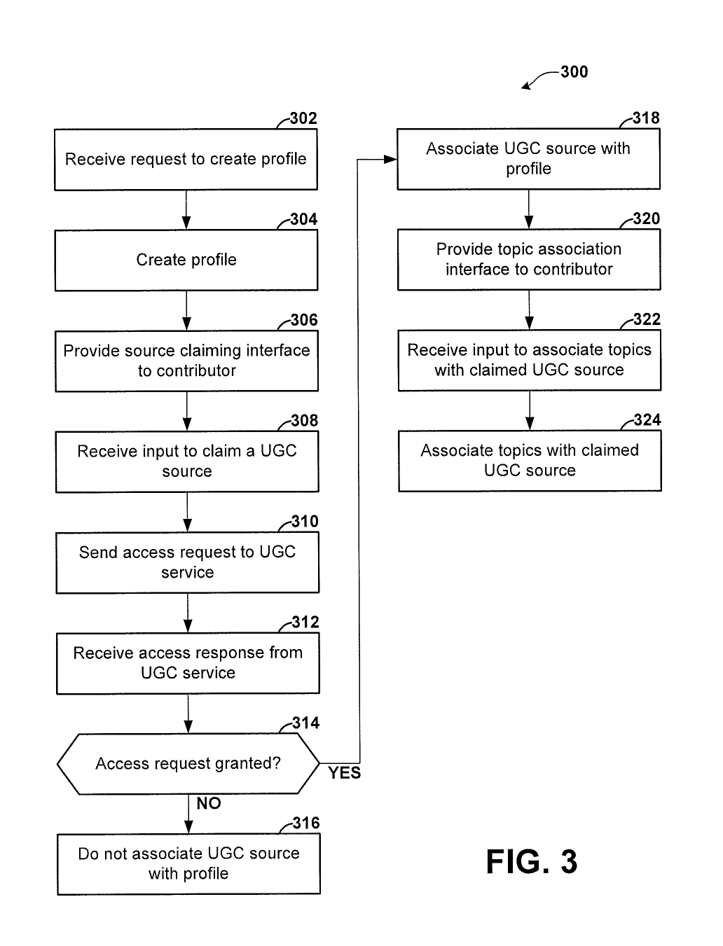

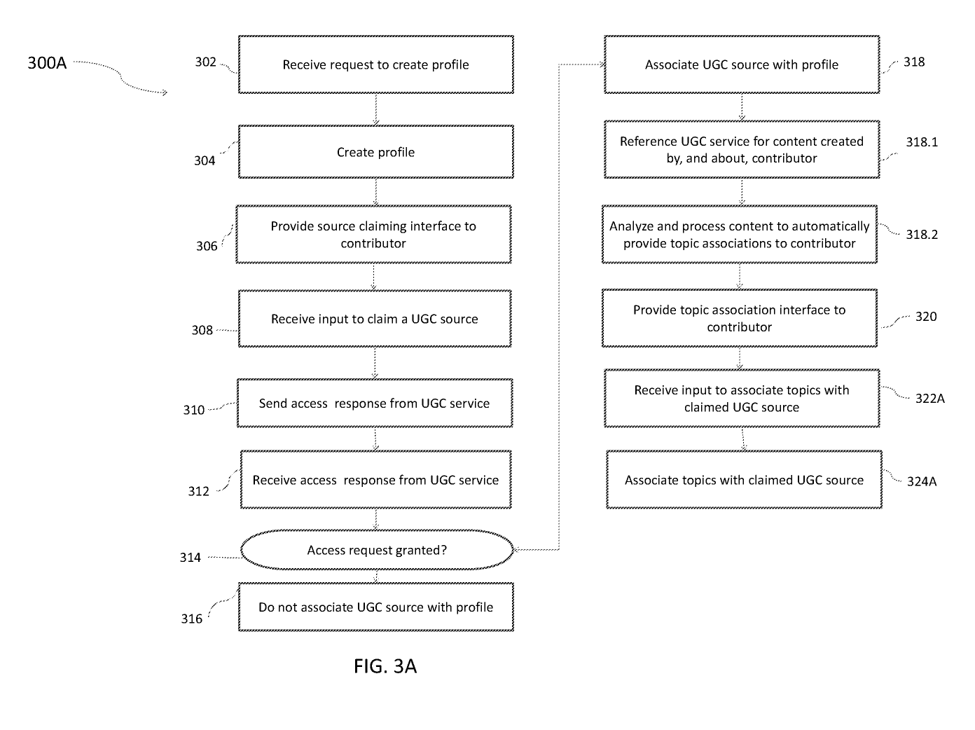

FIG. 3 is a flowchart illustrating an example operation 300 performed when a contributor creates a profile. As illustrated in the example of FIG. 3, the operation 300 begins when the social rank service 200 receives a request to create a profile (302). In various embodiments, the social rank service 200 can receive a request to create a profile in various ways. For example, in some embodiments, the social rank service 200 receives a request to create a profile via a web site. In response, the social rank service 200 creates a profile for the contributor (304). The profile may include a user name, an email address, biographical information, geographical information, and/or other personal information about the contributor. In other examples, the profiles can be created automatically regardless of whether or not a request is received. A user can thereupon “claim” the automatically created profile at a later point in time.

Initially, the profile is not associated with any UGC accounts. Accordingly, the social rank service 200 provides an account claiming interface to the contributor (306). The account claiming interface is a user interface that includes controls that allow the contributor to claim one or more UGC accounts as belonging to the contributor. For example, the account claiming interface can comprise controls that allow the contributor to claim Twitter accounts, blogs, Facebook profiles, MySpace pages, YouTube channels, or other UGC accounts. In some embodiments, the contributor may be required to pay a fee in order to claim more than a given number (e.g., two) of UGC accounts.

Subsequently, the social rank service 200 receives input from the contributor to claim a UGC account (308). For example, the social rank service 200 can receive input from the contributor to claim a Twitter account. In response to receiving the input to claim the UGC account, the social rank service 200 sends an access request to a UGC service that provides the UGC account (310). The access request is a request by the social rank service 200 to access the UGC account. For example, the access request can be a request to Facebook for access to the contributor's status updates. In some instances, the UGC service can prompt the contributor for authentication credentials before granting the access request. For example, Facebook may prompt the contributor to provide a username and password before allowing the social rank service 200 to access the contributor's status updates.

Subsequently, the social rank service 200 receives an access response from the UGC service (312). The access response indicates whether the social rank service 200 has been granted access to the UGC account. In response to receiving the access response, the social rank service 200 determines whether the access response indicates that the UGC service granted the access request (314). If the UGC service did not grant the access request (“NO” of 314), the social rank service 200 does not associate the UGC account with the profile (316). Otherwise, if the UGC service granted the access request (“YES” of 314), the social rank service 200 associates the UGC account with the profile (318).

Furthermore, the social rank service 200 provides a topic association interface to the contributor (320). The topic association interface includes controls that allow the contributor to associate various topics with claimed UGC accounts. In some examples, topics are automatically assigned to profiles based on information provided from various other sources. The user can be presented with the opportunity to add or remove topics.

Subsequently, the social rank service 200 receives input from the contributor to associate one or more topics with one or more claimed UGC accounts (322). In response to receiving the input to associate the topics with claimed UGC accounts, the social rank service 200 associates the one or more topics with the claimed UGC accounts (324). For example, a contributor has claimed a Twitter account and a blog. In this example, the contributor can associate the topics “wine,” “pinot noir,” and “sommelier” with the Twitter account. Furthermore, in this example, the contributor can associate the topics “ice fishing” and “vodka” with the blog.

In some examples, the user can claim multiple profiles and combine them under one account. This allows a user to increase their score by creating a more comprehensive “digital profile” that is comprised of multiple “social media profiles” from other networks.

FIG. 3A is a flowchart illustrating an alternative example of an operation 300A performed when a contributor creates a profile. As illustrated in the example of FIG. 3A, the operation 300A begins when the social rank service 200 receives a request to create a profile (302). In various embodiments, the social rank service 200 can receive a request to create a profile in various ways. For example, in some embodiments, the social rank service 200 receives a request to create a profile via a web site. In response, the social rank service 200 creates a profile for the contributor (304). The profile may include a user name, an email address, biographical information, geographical information, and/or other personal information about the contributor. In other examples, the profiles can be created automatically regardless of whether or not a request is received. A user can thereupon “claim” the automatically created profile at a later point in time.

Initially, the profile is not associated with any UGC accounts. Accordingly, the social rank service 200 provides an account claiming interface to the contributor (306). The account claiming interface is a user interface that includes controls that allow the contributor to claim one or more UGC accounts as belonging to the contributor. For example, the account claiming interface can comprise controls that allow the contributor to claim Twitter accounts, blogs, Facebook profiles, MySpace pages, YouTube channels, or other UGC accounts. In some embodiments, the contributor may be required to pay a fee in order to claim more than a given number (e.g., two) of UGC accounts.

Subsequently, the social rank service 200 receives input from the contributor to claim a UGC account (308). For example, the social rank service 200 can receive input from the contributor to claim a Twitter account. In response to receiving the input to claim the UGC account, the social rank service 200 sends an access request to a UGC service that provides the UGC account (310). The access request is a request by the social rank service 200 to access the UGC account. For example, the access request can be a request to Facebook for access to the contributor's status updates. In some instances, the UGC service can prompt the contributor for authentication credentials before granting the access request. For example, Facebook may prompt the contributor to provide a username and password before allowing the social rank service 200 to access the contributor's status updates.

Subsequently, the social rank service 200 receives an access response from the UGC service (312). The access response indicates whether the social rank service 200 has been granted access to the UGC account. In response to receiving the access response, the social rank service 200 determines whether the access response indicates that the UGC service granted the access request (314). If the UGC service did not grant the access request (“NO” of 314), the social rank service 200 does not associate the UGC account with the profile (316). Otherwise, if the UGC service granted the access request (“YES” of 314), the social rank service 200 associates the UGC account with the profile (318). The social rank service 200 references the UGC service for content created by, and about, a contributor (318.1). The social rank service 200 then analyzes and processes the content to automatically provide topic associations to the contributor (318.2).

Furthermore, the social rank service 200 provides a topic association interface to the contributor (320). The topic association interface includes controls that allow the contributor to associate various topics with claimed UGC accounts. In some examples, topics are automatically assigned to profiles based on information provided from various other sources. The user can be presented with the opportunity to add or remove topics.

Subsequently, the social rank service 200 receives input from the contributor to associate one or more topics with one or more profiles of UGC accounts (322A). In response to receiving the input to associate the topics with claimed UGC accounts, the social rank service 200 associates the one or more topics with the profiles of UGC accounts (324A).

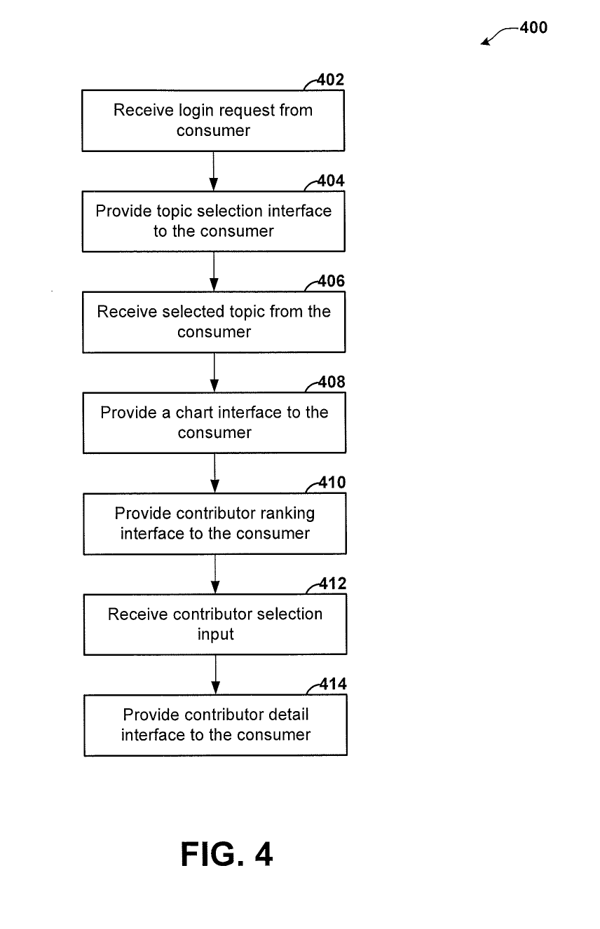

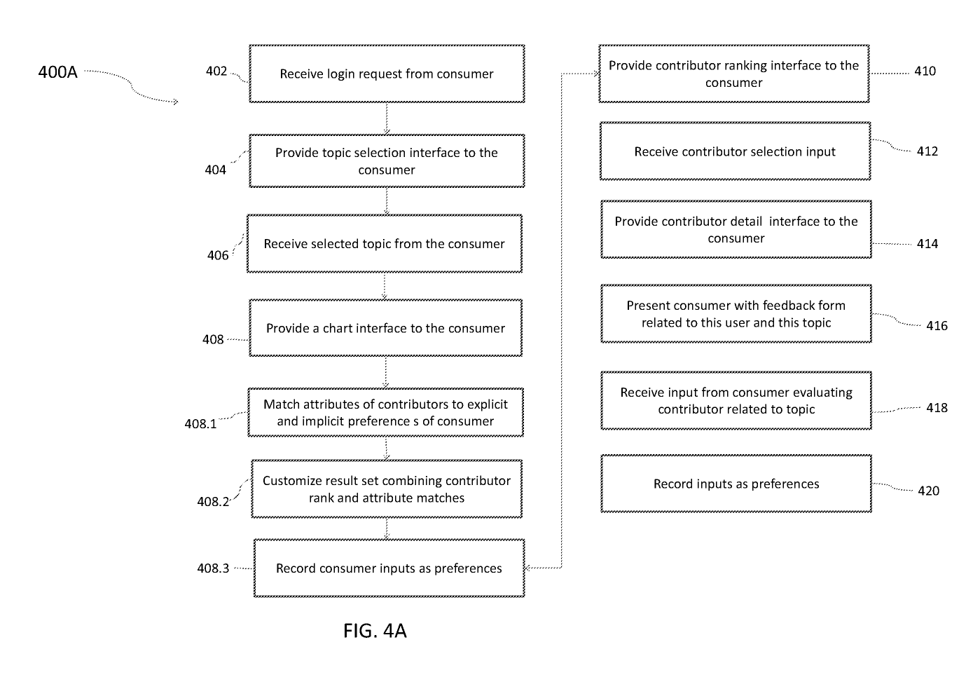

FIG. 4 is a flowchart illustrating an example operation 400 performed when the consumer 114 is looking for providers of relevant user-generated content. As illustrated in the example of FIG. 4, the operation 400 starts when the social rank service 200 receives a login request from the consumer 114 (402). The login request is a request from the consumer 114 to access the social rank service 200. The login request identifies the consumer 114 to the social rank service 200. In some embodiments, the consumer 114 does not need to provide a login request to access the social rank service 200. Furthermore, in some embodiments, the consumer 114 can provide the login request using a single sign on service, such as Facebook Connect or Twitter Connect.

After receiving the login request, the social rank service 200 provides a topic selection interface to the consumer (404). The topic selection interface enables the consumer 114 to select one or more topics of interest. After providing the topic selection interface to the consumer, the social rank service 200 receives topic selection input from the consumer 114 through the topic selection interface (406). The topic selection input indicates the topic selected by the consumer 114.

In various embodiments, the topic selection interface allows the consumer 114 to select topics in various ways. For example, the topic selection interface can have controls that allow the consumer 114 to search for topics by keyword. Furthermore, in some embodiments, the topic selection interface allows the consumer 114 to search for particular contributors.

FIG. 4A is a flowchart illustrating an alternative example operation 400A performed when the consumer 114 is looking for providers of relevant user-generated content. As illustrated in the example of FIG. 4, the operation 400 starts when the social rank service 200 receives a login request from the consumer 114 (402). The login request is a request from the consumer 114 to access the social rank service 200. The login request identifies the consumer 114 to the social rank service 200. In some embodiments, the consumer 114 does not need to provide a login request to access the social rank service 200. Furthermore, in some embodiments, the consumer 114 can provide the login request using a single sign on service, such as Facebook Connect or Twitter Connect.

After receiving the login request, the social rank service 200 provides a topic selection interface to the consumer (404). The topic selection interface enables the consumer 114 to select one or more topics of interest. After providing the topic selection interface to the consumer, the social rank service 200 receives topic selection input from the consumer 114 through the topic selection interface (406). The topic selection input indicates the topic selected by the consumer 114. After receiving the selected topic from the consumer 114, the social rank service 200 provides a chart interface to the consumer 114 (408). The chart interface comprises a chart that enables the consumer 114 to visualize the social ranks of contributors associated with the selected topic. The social rank service 200 matches attributes of contributors to explicit and implicit preferences of the consumer 114 (408.1). The chart interface then displays a customized results set combining contributor rank and attribute matches (408.2). The social rank system 200 then records consumer inputs as preferences (408.3).

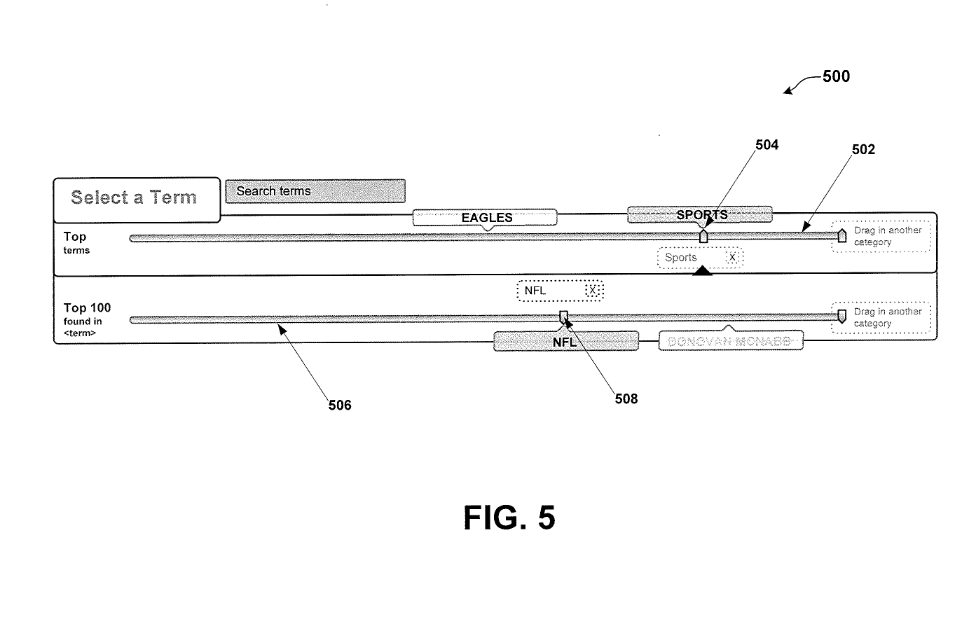

FIG. 5 is a screen illustration of an example topic selection interface 500. As illustrated in the example of FIG. 5, the topic selection interface 500 comprises a first slide bar 502. Different topics are associated with different positions along the first slide bar 502. As the consumer 114 drags an indicator 504 along the first slide bar 502, the topic selection interface 500 displays topic labels of different topics. By dragging the indicator 504 along the first slide bar 502 to an appropriate position, the consumer 114 is able to select a topic. In the example of FIG. 5, the consumer 114 has selected the topic “Sports.”

When the consumer 114 selects a topic using the first slide bar 502, the social rank service 200 identifies claimed UGC accounts that are associated with the selected topic. For example, if the selected topic is “sports,” the social rank service 200 identifies claimed UGC accounts that are associated with the topic “sports.” The social rank service 200 then identifies related topics. The related topics are the topics that are most frequently associated with the identified UGC accounts. For example, the social rank service 200 can identify the topics “NFL,” “soccer,” “nutrition,” “LeBron James,” “stadiums,” and “hernia” as the related topics. It should be appreciated that the related topics do not necessarily bear any ontological or hierarchical relationship to the initially selected topic. For instance, “hernia” is not a type of “sport.”

After the social rank service 200 identifies the related topics, the social rank service 200 updates the topic selection interface 500 to include a second slide bar 506. Different positions along the second slide bar 506 correspond to different ones of the related topics. As the consumer 114 drags the indicator 508 along the second slide bar 506, the topic selection interface 500 displays topic labels of different ones of the related topics. By dragging the indicator 508 along the second slide bar 506 to an appropriate position, the consumer 114 is able to select one of the related topics. In the example of FIG. 5, the consumer 114 has selected the topic “NFL” using the second slide bar 506. The topic “NFL” is a topic related to the topic “Sports” indicated using the first slide bar 502.

Furthermore, in some embodiments, the topic selection interface 500 allows the consumer 114 to pre-select multiple topics. By pre-selecting multiple topics, the consumer 114 can easily switch between multiple topics of interest. For instance, the consumer 114 can position another indicator on the first slide bar 502 to select a different topic. In the example of FIG. 5, the consumer 114 has previously positioned an indicator on the first slide bar 502 to select the topic “Eagles” and has previously positioned an indicator on the second slide bar 506 to select the topic “Donovan McNabb.” By clicking on a topic label for “Eagles” or “Donovan McNabb,” the consumer 114 is able to easily select the topic “Donovan McNabb” again.

With continuing reference to FIG. 4, after receiving the selected topic from the consumer 114, the social rank service 200 provides a chart interface to the consumer 114 (408). The chart interface comprises a chart that enables the consumer 114 to visualize the social ranks of contributors associated with the selected topic. In some embodiments, the chart interface appears within a larger user interface concurrently with the topic selection interface. In various embodiments, the chart interface can have various appearances and formats.

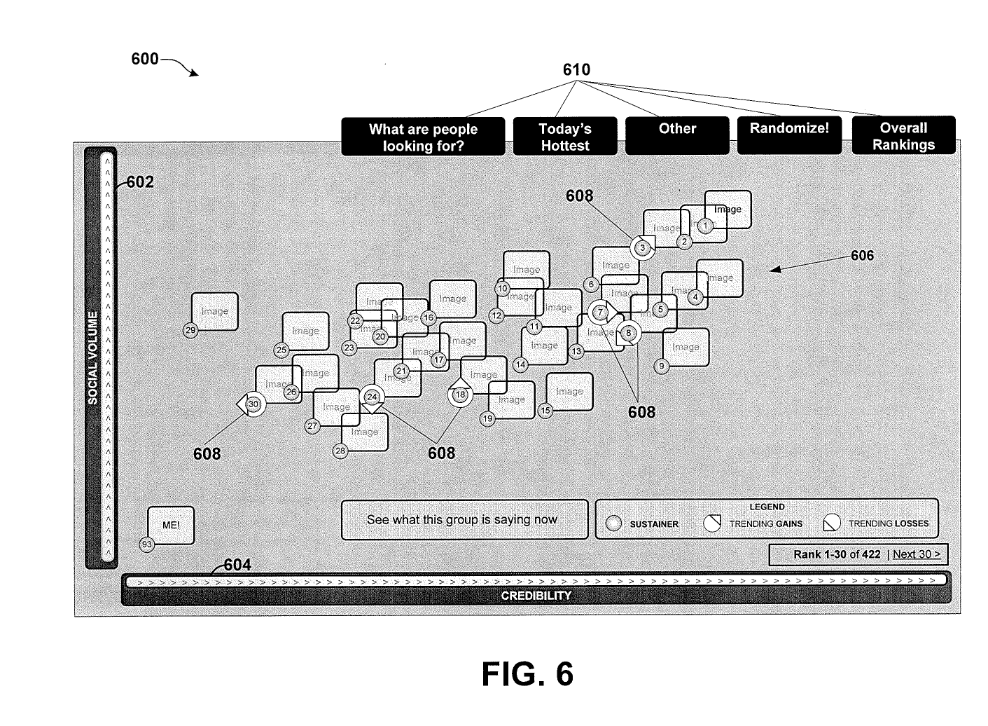

FIG. 6 is a screen illustration of an example chart interface 600. As illustrated in the example of FIG. 6, the chart interface 600 comprises a social volume axis 602 and a credibility axis 604. Furthermore, the chart interface 600 contains one or more contributor icons 606. Each of the contributor icons 606 is associated with a different profile. In some embodiments, each of the contributor icons 606 contains an image associated with a different one of the contributors. The social rank service 200 can automatically pull this image from a UGC account, such as a Facebook profile or a Twitter account.

The positions of the contributor icons 606 within the chart interface 600 are dependent on the volume scores of the contributors and the credibility scores of the contributors. For example, a contributor icon associated with a contributor who has a high volume score for a topic is located higher on the volume axis 602 than a contributor icon associated with a contributor who has a low volume score for the topic. Similarly, a contributor icon associated with a contributor who has a high credibility score is located to the right on the credibility axis 604 of a contributor icon associated with a contributor who has a low credibility score. Because the contributors' social ranks are based on both the contributors' volume scores and the contributors' credibility scores, the contributor icon associated with the contributor having the highest social rank is generally at the top right of the chart interface 600 and the contributor icon associated with the contributor having the lowest social rank is generally at the bottom left of the chart interface 600.

Furthermore, as illustrated in the example of FIG. 6, the contributor icons 606 can be associated with trend indicators 608. The trend indicators 608 indicate whether the volume scores of associated contributors have been increasing, decreasing, or staying the same. Moreover, each of the trend indicators 608 indicates whether the credibility scores of the contributors have been increasing, decreasing, or staying the same. For example, if the volume score of a given contributor has been increasing and the credibility score of the given contributor has been rising, the trend indicator associated with the given contributor points up and to the right. In another example, if the volume score of a given contributor has been declining, but the credibility score of the given contributor has stayed the same, the trend indicator associated with the given contributor points down.

The chart interface 600 also comprises a set of standard topic controls 610. When the consumer 114 selects one of the standard topic controls 610, the social rank service 200 updates the chart interface 600 to display contributor icons positioned based on the social ranks of contributors with regard to a predefined topic. For example, when the consumer 114 selects the standard topic control 610 labeled “what are people looking for?,” the social rank service 200 updates the chart interface 600 to display contributor icons that are positioned based on the social ranks of contributors with regard to a topic that users of the social rank service 200 are currently selecting at the greatest frequency. When the consumer 114 selects the standard topic control 610 labeled “today's hottest,” the social rank service 200 updates the chart interface 600 to display contributor icons that are positioned based on the social ranks of contributors regarding one or more topics that have selection rates that are increasing. When the consumer 114 selects the standard topic control 610 labeled “Randomize',” the social rank service 200 updates the chart interface 600 to display contributor icons that are positioned based on the social ranks of contributors with regard to a topic that is selected at random.

In some embodiments, the chart interface 600 displays a popup element when the consumer 114 positions a cursor over one of the contributor icons 606. The popup element contains additional information about the contributor associated with the contributor icon. In various embodiments, the popup element can contain various types of additional information about the contributor. For example, the popup element can contain an image of the contributor, a user name of the contributor, the latest content generated by the contributor and/or a trend line that indicates the social rank of the contributor over time. In various embodiments, a contributor's number of followers may be depicted in various ways, including the size of the icon, or an associated symbol, representing the contributor. In this way, the chart interface 600 enables the consumer 114 to quickly access details regarding each of the contributors associated with the contributor icons 606.

In some embodiments, the topic selection interface 500 allows the consumer 114 to select an overall topic. When the consumer 114 selects the overall topic, the positions of the contributor icons 606 are not tied to any particular topic. Rather, the positions of the contributor icons 606 are based on the contributors overall volume scores and overall credibility scores without regard to topic. In some embodiments, the indicator 504 in the first slide bar 502 of the topic selection interface 500 is positioned by default at a location on the first slide bar 502 associated with the overall topic.

In some embodiments, the topic selection interface includes one or more controls that enable the consumer 114 to specify a geographic region or location. If the consumer 114 uses such controls to specify a geographic region or location, the chart interface only includes contributor icons associated with contributors in the specified geographic region or location.

Reference is now made again to FIG. 4. In addition to providing the chart interface to the consumer 114, the social rank service 200 also provides a contributor ranking interface to the consumer 114 (410). The contributor ranking interface lists contributors based on the social ranks of the contributors with regard to the selected topic. In some embodiments, the contributor ranking interface appears within a larger user interface concurrently with the topic selection interface and/or the chart interface.

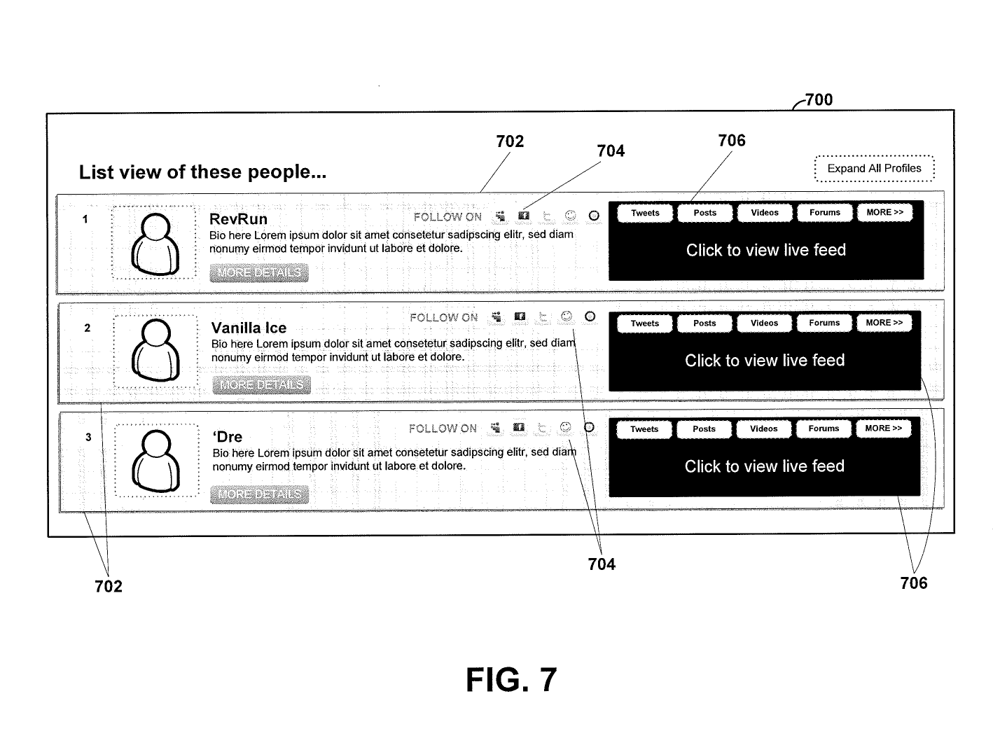

FIG. 7 is a screen illustration of an example contributor ranking interface 700. As illustrated in the example of FIG. 7, the contributor ranking interface 700 includes a set of contributor items 702. Each of the contributor items 702 contains information about a different contributor. For instance, in the example of FIG. 7, the contributor items 702 include pictures, usernames, and biographical data about different contributors. In addition, the contributor items 702 comprise controls 704 that enable the consumer 114 to subscribe to content generated by the contributors on various UGC accounts claimed by the contributors. The contributor items 702 also comprise elements 706 that enable the consumer 114 to see a feed of content generated by the contributors on various UGC accounts claimed by the contributors.

The contributor items 702 are arranged in the contributor ranking interface 700 based on the social ranks of the contributors. In various embodiments, the social rank service 200 calculates the social ranks of contributors in various ways. For example, in some embodiments, the social rank service 200 calculates the social ranks of the contributors by comparing the social scores of the contributors. The social score for a contributor is a sum of the contributor's rule scores. The social rank service 200 generates the contributor's rule scores by applying scoring rules to the UGC accounts claimed by the contributor. To calculate a contributor's social score for a particular topic, the social rank service 200 only applies the scoring rules to UGC accounts that are claimed by the contributor and that are associated with the topic. To calculate a contributor's overall social score, the social rank service 200 applies the scoring rules to each of the UGC accounts claimed by the contributor.

In this example, there are different scoring rules for different types of content generated by the contributors 112. The following table illustrates an example set of scoring rules.

TABLE 1

| Rule | Content | | | |
|---|---|---|---|---|
| Number | Type | Ranking Criteria | Formula | Weight |
| 1 | Global | Interaction from | [peer's points]/ | 1000 |
| | | others with high | [total global | |
| | | rank. All rules | points] | |
| | | are multiplied | | |
| | | by this factor. | | |
| 2 | Facebook | Calculate optimal | 1/\|messages | 1 |
| | Personal | frequency from | per day - | |
| | Profile | others who receive | Optimal | |
| | Wall Posts | comments, score | Frequency\| | |
| | | being close to | | |
| | | optimal frequency. | | |
| 3 | Facebook | Messages with | [messages] | |
| | Personal | high ranking | | |
| | Profile | profiles are good | | |
| | Messages | | | |
| 4 | Facebook | More comments | [comments] | 3 |
| | Personal | are good | | |
| | Profile | | | |
| | Comments | | | |
| 5 | Facebook | Calculate optimal | 1/\|links | 0.3 |
| | Personal | frequency from | per day - | |
| | Profile | others who receive | Optimal | |
| | Link Posts | comments, score | Frequency\| | |
| | | higher for being | | |
| | | close to optimal | | |
| | | frequency | | |
| 6 | Facebook | Calculate optimal | 1/\|videos | 0.3 |
| | Personal | frequency from | per day - | |
| | Profile | others who receive | Optimal | |
| | Video Posts | comments, score | Frequency\| | |
| | | higher for being | | |
| | | close to optimal | | |
| | | frequency | | |
| 7 | Facebook | Calculate optimal | 1/\|image | 0.2 |
| | Persona | frequency from | per day - | |
| | Profile Images | others who receive | Optimal | |
| | | comments, score | Frequency\| | |
| | | higher for being | | |
| | | close to optimal | | |
| | | frequency | | |
| 8 | Facebook Fan | Calculate optimal | 1/\|messages | 1 |
| | Pages | frequency from | per day - | |
| | Wall Posts | others who receive | Optimal | |
| | | comments, score | Frequency\| | |
| | | higher for being | | |
| | | close to optimal | | |
| | | frequency | | |
| 9 | Facebook Fan | Messages with | [messages] | |
| | Pages | high ranking | | |
| | Messages | profiles are good | | |
| | (Inbox) | | | |
| 10 | Facebook Fan | More comments | [comments] | 3 |
| | Pages | are good | | |
| | Comments | | | |
| | on posts | | | |
| 11 | Facebook Fan | Calculate optimal | 1/\|links | 0.3 |
| | Pages Link | frequency from | per day - | |
| | Posts | others who receive | Optimal | |
| | | comments, score | Frequency\| | |
| | | higher for being | | |
| | | close to optimal | | |
| | | frequency | | |
| 12 | Facebook Fan | Calculate optimal | 1/\|videos | 0.3 |
| | Pages Video | frequency from | per day - l | |
| | Posts | others who receive | Optima | |
| | | comments, score | Frequency\| | |
| | | higher for being | | |
| | | close to optimal | | |
| | | frequency | | |
| 13 | Facebook Fan | Calculate optimal | 1/\|image | 0.2 |
| | Pages Images | frequency from | per day - | |
| | | others who receive | Optimal | |
| | | comments, score | Frequency\| | |
| | | higher for being | | |
| | | close to optimal | | |
| | | frequency | | |
| 14 | Twitter Public | Calculate optimal | 1/\|tweet | 1 |
| | Search Tweets | frequency from | per day - | |
| | | others who receive | Optimal | |
| | | comments, score | Frequency\| | |
| | | higher for being | | |
| | | close to optimal | | |
| | | frequency | | |
| 15 | Twitter Public | Mentions from | mention | 1 |
| | Search | high ranking | | |
| | Mentions | profiles are good | | |
| 16 | Twitter Public | No scoring value | | |
| | Search Hash | | | |
| | Trends | | | |
| 17 | Twitter Public | Retweets from | single retweet | 1 |
| | Search | high ranking | | |
| | Retweets | profiles are good | | |
| 18 | Twitter | Being added to | on someone's | 5 |
| | Listorious | lists with high | Twitter list | |
| | Lists | ranking are good | | |
| 19 | Twitter Public | More followers | 1 follower | (1/1000) |
| | Search | are good, as | | |
| | Followers | long as they are | | |
| | | credible profiles | | |
| | | (don't want to give | | |
| | | credit to scripts | | |
| | | and bots, auto- | | |
| | | spammers) | | |
| 20 | Twitter Public | The original | single tweet | 1 |
| | Search Links | contributor | | |
| | in Tweets | should get a lot | | |
| | | of credit, and the | | |
| | | re-tweeter should | | |
| | | get only partial | | |
| | | credit (already | | |
| | | covered in | | |
| | | Retweets) | | |
| 21 | Google Blogs, | Calculate optimal | 1/\|post | 1 |
| | Blog Posts, | frequency from | per day - | |
| | Number of | others who receive | Optimal | |
| | Posts | comments, score | Frequency\| | |
| | | higher for being | | |
| | | close to optimal | | |
| | | frequency | | |
| 22 | Google Blogs, | More comments | [comments] | 3 |
| | Blog Posts, | are good | | |
| | Comments | | | |
| 23 | Public Blogs, | Calculate optimal | 1/\|post | 1 |
| | Blog Posts, | frequency from | per day - | |
| | Number of | others who receive | Optimal | |
| | Posts | comments, score | Frequency\| | |
| | | higher for being | | |
| | | close to optimal | | |
| | | frequency | | |
| 24 | Public Blogs, | More comments | [comments] | 3 |
| | Blog Posts, | are good | | |
| | Comments | | | |
| 25 | YouTube, | More views | [views] | 0.00001 |
| | Public Search, | are good | | |
| | Number | | | |
| | of Views | | | |
| 26 | YouTube, | Higher rating | | |
| | Public | is good | | |
| | Search, | | | |
| | Rating | | | |
| 27 | YouTube, | More comments | [comments] | 0.1 |
| | Public | are good | | |
| | Search, # of | | | |
| | Comments | | | |
| 28 | Forums, | Calculate optimal | 1/\|post per | 1 |
| | Forums, | frequency from | day - | |
| | New Posts | others who post, | Optimal | |
| | | score higher | Frequency\| | |
| | | for being close | | |
| | | to optimal | | |
| | | frequency | | |
| 29 | Forums, | Calculate optimal | 1/\|reply | 1 |
| | Forums, | frequency from | per day - | |
| | Replies | others who reply, | Optimal | |
| | | score higher | Frequency\| | |
| | | for being close | | |
| | | to optimal | | |
| | | frequency | | |

The social rank service 200 applies the scoring rules in Table 1 to appropriate ones of the UGC accounts claimed by a contributor. For example, if a contributor has claimed a Google Blogs account, the social rank service 200 applies scoring rules 21-23. In this example, if the contributor has not claimed a Google Blogs account, the social rank service 200 does not apply scoring rules 21-23. If a contributor has claimed multiple UGC accounts belonging to the same type (e.g., two Twitter accounts), the social rank service 200 applies the scoring rules for each of these UGC accounts separately.

To apply a scoring rule of a UGC account, the social rank service 200 generates an initial score by applying the formula of the scoring rule. For instance, to apply scoring rule 28, the social rank service 200 generates an initial score by calculating 1 divided by the absolute value of the difference between the contributor's posts per day minus an optimal number of posts per day (i.e., an optimal frequency). The social rank service 200 then multiplies the initial score by the weight of the scoring rule. For instance, with scoring rule 27, the social rank service 200 multiplies the initial score by 0.1. In some examples, the score can be further modified based on interaction with other profiles.

In Table 1, the formulas of some of the rules include optimal frequency parameters. The optimal frequency parameters can be different in different formulas. An optimal frequency parameter indicates an amount of content that consumers likely want to receive. For example, consumers may want to receive about four tweets per day from a UGC account. In this example, consumers may get annoyed if they receive too many or too few tweets from a UGC account. The optimal frequency parameters can be generated in various ways. For example, the optimal frequency parameters can be generated manually using opinion research, such as focus groups and polls. In another example, the optimal frequency parameters can be dynamically generated on a periodic basis by analyzing the amount of content generated by the most widely followed contributors.

Furthermore, in some embodiments, the social rank service 200 can use different optimal frequency parameters when the social rank service 200 applies a scoring rule to UGC accounts associated with different topics. For example, a contributor has claimed a first Twitter account associated with “Finance” and a second Twitter account associated with “Health.” In this example, consumers may want to receive tweets regarding financial news eight times a day while consumers may want to receive tweets regarding health news once a day. Accordingly, in this example, the social rank service 200 can apply a scoring rule to the first Twitter account using an optimal frequency parameter of 8 and can apply the scoring rule to the second Twitter account using an optimal frequency parameter of 1.

In some embodiments, the set of scoring rules can be edited over time. For example, new scoring rules can be added or removed from the set of scoring rules. In another example, the formulas and weights of the scoring rules can be changed in order to provide appropriate social scores.

Some of the scoring rules in Table 1 are volume scoring rules and some of the scoring rules in Table 1 are credibility scoring rules. Volume scoring rules are scoring rules that the social rank service 200 uses to calculate the contributors' volume scores. Credibility scoring rules are scoring rules that the social rank service 200 uses to calculate the contributors' credibility scores. For instance, in Table 1, scoring rule 2 is a volume scoring rule because scoring rule 2 deals with the number of Facebook wall posts generated by a contributor. In contrast, scoring rule 4 is a credibility scoring rule because scoring rule 4 deals with the number of comments posted by consumers on the contributor's Facebook wall posts.

It should be appreciated that the scoring rules in Table 1 are provided as an example. The social rank service 200 can use many other scoring rules. For example, some scoring rules can be tied to particular topics. For instance, a scoring rule might only be applicable to topics associated with sports. In another example, some scoring rules can provide different credibility scores to contributors depending on the geographic locations of the contributors and the people who consume content from the contributors. In this example, the social rank service 200 can use a credibility scoring rule that provides a contributor with a higher rule score if the contributor generates content while in a given geographic location. Similarly, the social rank server 200 can use a credibility scoring rule that provide a contributor with an enhanced credibility score if a certain proportion of consumer comments regarding the contributor's content are generated in a given geographic location. In this example, the geographic locations of the contributor and the consumers can be determined automatically or can be explicitly provided by the contributor and/or the consumers. In another example, the some scoring rules can provide different credibility scores to contributors depending on the types of devices used by the contributors and the types of devices used by consumers to consume content generated by the contributors. In this example, a credibility scoring rule can, for instance, apply to the topic “Apple” and provide an enhanced credibility score to a contributor when the contributor generates content using a computing device made by Apple, Inc. or when a majority of the people who consume the contributor's content use a computing device made by Apple, Inc. In this way, the contributor's credibility score regarding the topic “Apple” is enhanced if the contributor actually uses an Apple computing device and is read by people who use Apple computing devices. Many other scoring rules are possible.

Reference is now made again to FIG. 4. After the social rank service 200 provides the chart interface to the consumer 114, the social rank service 200 can receive contributor selection input from the consumer 114 (412). The contributor selection input indicates a selection by the consumer 114 of one of the contributors. In embodiments, the social rank service 200 can receive the contributor selection input in various ways. For example, the social rank service 200 can receive the contributor selection input when the consumer 114 clicks on one of the contributor icons 606 in the chart interface 600.

In response to the contributor selection input, the social rank service 200 provides a contributor detail interface to the consumer 114 (414). The contributor detail interface provides details about a contributor. In some embodiments, the contributor detail interface appears within a larger user interface concurrently with the topic selection interface, the chart interface and/or the contributor ranking interface. In various embodiments, the contributor detail interface has various formats and appearances.

Reference is now made again to FIG. 4A. After the social rank system 200 provides a contributor detail interface to the consumer 114, the consumer is presented with a feedback form related to the topic (416). The social rank service 200 receives input from the consumer 114 evaluating the contributor 112, related to the topic (418). The social rank system records the consumer inputs as preferences (420).

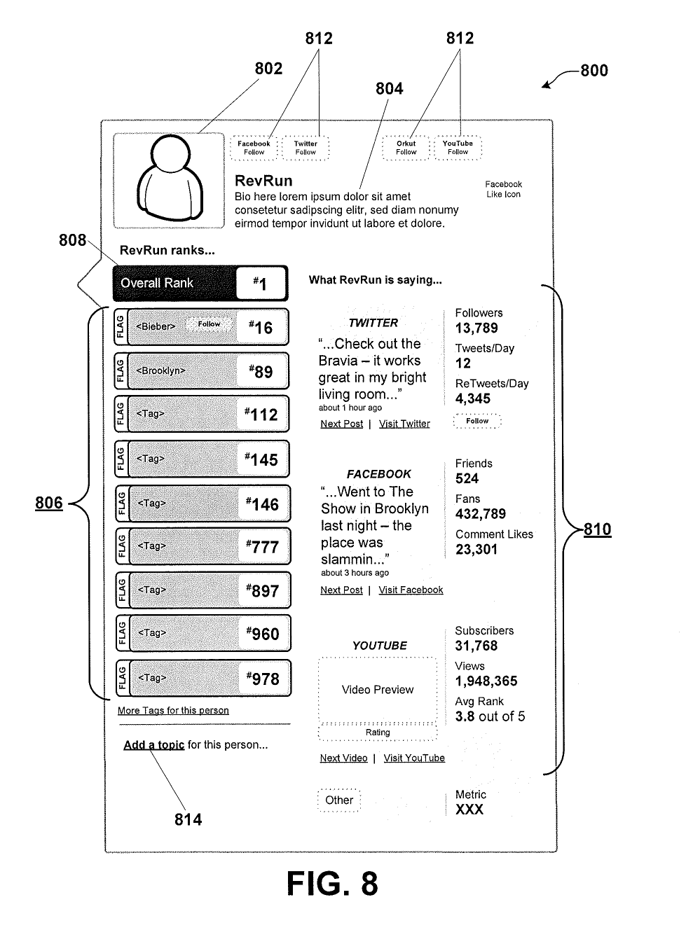

FIG. 8 is a screen illustration of an example contributor detail interface 800. As illustrated in the example of FIG. 8, the contributor detail interface 800 includes an image 802 of a contributor. In various embodiments, the image 802 may come from various sources. For example, in some embodiments, the social rank service 200 can pull the image 802 from one or more other UGC accounts, such as a Facebook profile. In another example, the contributor provides the image 802 to the social rank service 200.

The contributor detail interface 800 also comprises a username and biography section 804 for the contributor. The biography section 804 contains text that provides biographical information about the contributor. In various embodiments, the biographical information can have various sources. For example, the biographical information can be provided directly by the contributor. In another example, the social rank service 200 can automatically pull the biographical information from a UGC account (such as a Facebook profile) claimed by the contributor.

In addition, the contributor detail interface 800 comprises a topic list 806. The topic list 806 lists topics associated with UGC accounts claimed by the contributor. Furthermore, the topics in the topic list 806 include the social ranks of the contributor with regard to different topics. For example, the contributor has a social rank of 16 with regard to the topic “Bieber” and a social rank of 89 with regard to the topic “Brooklyn.” The contributor detail interface 800 also comprises an overall rank element 808. The overall rank element 808 indicates the overall social rank for the contributor.

Furthermore, the contributor detail interface 800 comprises a recent activity area 810. The recent activity area 810 comprises content recently generated by the contributor on the UGC accounts claimed by the contributor. In the example of FIG. 8, the contributor detail interface 800 comprises an area that shows recently generated content on a Twitter account claimed by the contributor, an area that shows recently generated content on a Facebook account claimed by the contributor, and an area that shows a recently posted video on a YouTube account claimed by the contributor.

The recent activity area 810 also comprises information about the UGC accounts claimed by the contributor. For instance, the recent activity area 810 comprises text indicating the number of followers for the contributor's Twitter account, the number of tweets generated by the contributor per day, and the number of times a tweet generated by the contributor is retweeted. Furthermore, in the example of FIG. 8, the recent activity area 810 comprises text indicating the number of friends of the contributor's Facebook account, the number of fans of the contributor's Facebook account, and the number of users who have commented on or liked content on the contributor's Facebook account. Furthermore, in the example of FIG. 8, the recent activity area 810 comprises text indicating the number of people who subscribe to the contributor's YouTube channel, a number of times that videos posted to the contributor's YouTube channel have been viewed, and the average rank of videos posted to the contributor's YouTube channel.

The contributor detail interface 800 also comprises controls 812 that allow the consumer 114 to subscribe to the UGC accounts claimed by the contributor. In the example of FIG. 8, the contributor has claimed a Facebook account, a Twitter account, an Orkut account, and a YouTube channel. Accordingly, the controls 812 include a control to subscribe to the contributor's Facebook account, a control to subscribe to the contributor's Twitter account, a control to subscribe to the contributor's Orkut account, and a control to subscribe to the contributor's YouTube channel.

In addition, the contributor detail interface 800 includes a control 814 that allows the consumer 114 to associate a topic with a UGC account claimed by the contributor. For example, the consumer 114 can use the control 814 to associate the topic “radiology” with a Twitter account claimed by the contributor.

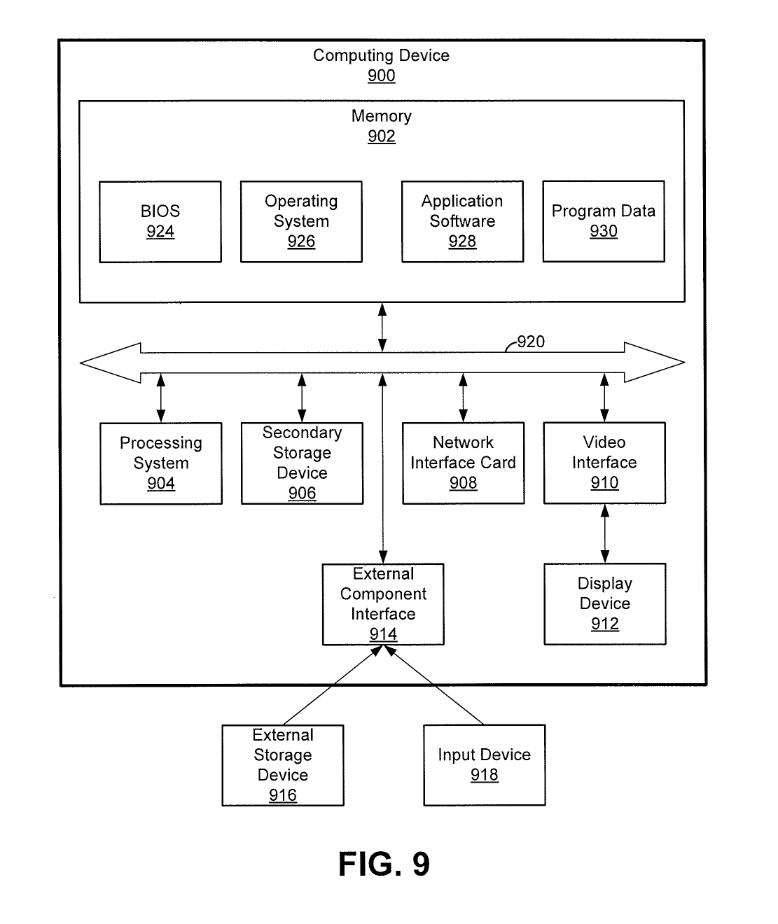

FIG. 9 is a block diagram illustrating an example computing device 900. In some embodiments, the UGC servers 102, the contributor client devices 104, the aggregation server 106 and/or the consumer client device 108 are implemented using one or more computing devices like the computing device 900. It should be appreciated that in other embodiments, the UGC servers 102, the contributor client devices 104, the aggregation server 106 and/or the consumer client device 108 are implemented using computing devices having hardware components other than those illustrated in the example of FIG. 9.

In different embodiments, computing devices are implemented in different ways. For instance, in the example of FIG. 9, the computing device 900 comprises a memory 902, a processing system 904, a secondary storage device 906, a network interface card 908, a video interface 910, a display device 912, an external component interface 914, an external storage device 916, an input device 918, and a communication medium 920. In other embodiments, computing devices are implemented using more or fewer hardware components. For instance, in another example embodiment, a computing device does not include a video interface, a display device, an external storage device, or an input device.

The term computer readable media as used herein may include computer storage media. Computer storage media may include volatile and nonvolatile, removable and non-removable media implemented in any method or technology for storage of information, such as computer readable instructions, data structures, program modules, or other data. The memory 902 includes one or more computer storage media capable of storing data and/or instructions. As used in this document, a computer storage medium is a device or article of manufacture that stores data and/or software instructions readable by a computing device. In different embodiments, the memory 902 is implemented in different ways. For instance, in various embodiments, the memory 902 is implemented using various types of computer storage media. Example types of computer storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The processing system 904 includes one or more physical integrated circuits that selectively execute software instructions. In various embodiments, the processing system 904 is implemented in various ways. For instance, in one example embodiment, the processing system 904 is implemented as one or more processing cores. For instance, in this example embodiment, the processing system 904 may be implemented as one or more Intel Core 2 microprocessors. In another example embodiment, the processing system 904 is implemented as one or more separate microprocessors. In yet another example embodiment, the processing system 904 is implemented as an ASIC that provides specific functionality. In yet another example embodiment, the processing system 904 provides specific functionality by using an ASIC and by executing software instructions.

In different embodiments, the processing system 904 executes software instructions in different instruction sets. For instance, in various embodiments, the processing system 904 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 906 includes one or more computer-readable data storage media. The secondary storage device 906 stores data and software instructions not directly accessible by the processing system 904. In other words, the processing system 904 performs an I/O operation to retrieve data and/or software instructions from the secondary storage device 906. In various embodiments, the secondary storage device 906 is implemented by various types of computer-readable data storage media. For instance, the secondary storage device 906 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 908 enables the computing device 900 to send data to and receive data from a computer communication network. In different embodiments, the network interface card 908 is implemented in different ways. For example, in various embodiments, the network interface card 908 is implemented as an Ethernet interface, a token-ring network interface, a fiber optic network interface, a wireless network interface (e.g., WiFi, WiMax, etc.), or another type of network interface.

The video interface 910 enables the computing device 900 to output video information to the display device 912. In different embodiments, the video interface 910 is implemented in different ways. For instance, in one example embodiment, the video interface 910 is integrated into a motherboard of the computing device 900. In another example embodiment, the video interface 910 is a video expansion card. Example types of video expansion cards include Radeon graphics cards manufactured by Advanced Micro Devices, Inc. of Sunnyvale, Calif., Geforce graphics cards manufactured by Nvidia Corporation of Santa Clara, Calif., and other types of graphics cards.

In various embodiments, the display device 912 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 910 communicates with the display device 912 in various ways. For instance, in various embodiments, the video interface 910 communicates with the display device 912 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 914 enables the computing device 900 to communicate with external devices. In various embodiments, the external component interface 914 is implemented in different ways. For instance, in one example embodiment, the external component interface 914 is a USB interface. In other example embodiments, the computing device 900 is a FireWire interface, a serial port interface, a parallel port interface, a PS/2 interface, and/or another type of interface that enables the computing device 900 to communicate with external components.

In different embodiments, the external component interface 914 enables the computing device 900 to communicate with different external components. For instance, in the example of FIG. 9, the external component interface 914 enables the computing device 900 to communicate with the external storage device 916 and the input device 918. In other embodiments, the external component interface 914 enables the computing device 900 to communicate with more or fewer external components. Other example types of external components include, but are not limited to, speakers, phone charging jacks, modems, media player docks, other computing devices, scanners, digital cameras, a fingerprint reader, and other devices that can be connected to the computing device 900.

The external storage device 916 is an external component comprising one or more computer readable data storage media. Different implementations of the computing device 900 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 918 is an external component that provides user input to the computing device 900. Different implementations of the computing device 900 interface with different types of input devices. Example types of input devices include, but are not limited to, keyboards, mice, trackballs, stylus input devices, key pads, microphones, joysticks, touch-sensitive display screens, and other types of devices that provide user input to the computing device 900.

The communications medium 920 facilitates communication among the hardware components of the computing device 900. In different embodiments, the communications medium 920 facilitates communication among different components of the computing device 900. For instance, in the example of FIG. 9, the communications medium 920 facilitates communication among the memory 902, the processing system 904, the secondary storage device 906, the network interface card 908, the video interface 910, and the external component interface 914. In different implementations of the computing device 900, the communications medium 920 is implemented in different ways. For instance, in different implementations of the computing device 900, the communications medium 920 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 902 stores various types of data and/or software instructions. For instance, in the example of FIG. 9, the memory 902 stores a Basic Input/Output System (BIOS) 924, an operating system 926, application software 928, and program data 930. The BIOS 924 includes a set of software instructions that, when executed by the processing system 904, cause the computing device 900 to boot up. The operating system 926 includes a set of software instructions that, when executed by the processing system 904, cause the computing device 900 to provide an operating system that coordinates the activities and sharing of resources of the computing device 900. Example types of operating systems include, but are not limited to, Microsoft Windows®, Linux, Unix, Apple OS X, Apple iOS, Google Chrome OS, Google Android OS, and so on. The application software 928 includes a set of software instructions that, when executed by the processing system 904, cause the computing device 900 to provide applications. The program data 930 is data generated and/or used by the application software 928.

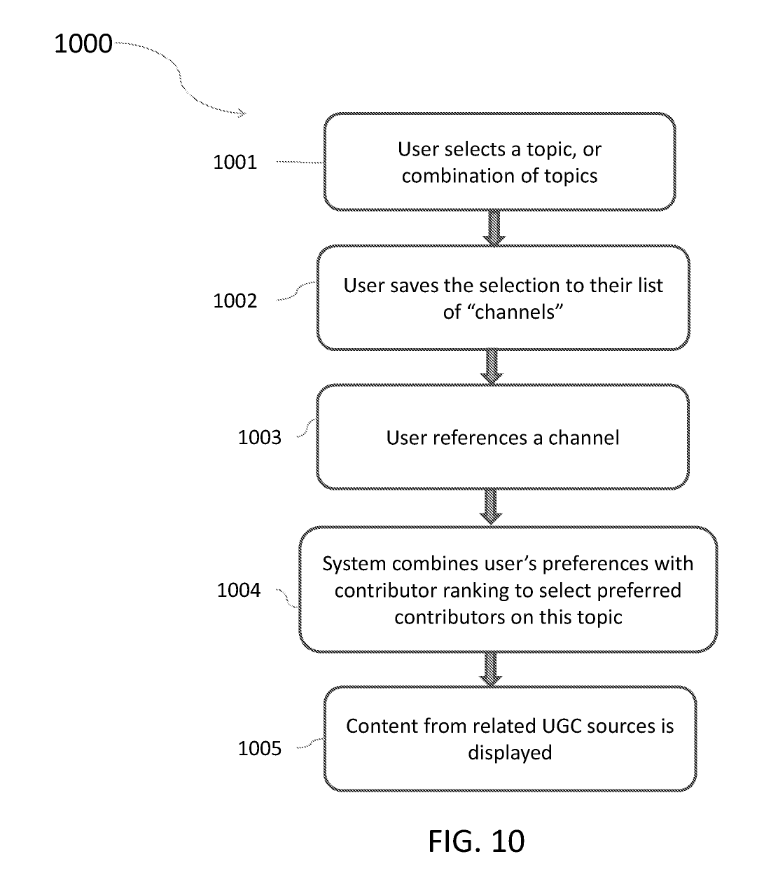

FIG. 10 is a flowchart illustrating an example operation 1000 performed by the present invention to display dynamic topic channels. As illustrated in FIG. 10, the operation 1000 begins when the social rank service 200 receives a selection by the consumer 114 of a topic or a combination of topics (1001). The consumer 114 then saves the selection to a list of topic groups, or channels (1002). The consumer then references a channel (1003). The social rank service 200 then combines the consumer's preferences with contributor 112 rankings to select preferred contributors on this topic (1004). The social rank service 200 then displays content from related UGC sources (1005).

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

What is claimed is:

1. A method comprising:
providing a computing system; and
providing, by the computing system, a social rank service to a consumer, the social rank service enabling the consumer to compare social ranks of contributors who generate and distribute user-generated content (UGC) regarding a topic,
wherein the social ranks of the contributors with regard to the topic are based on volume scores of the contributors and credibility scores of the contributors,
wherein the volume scores of the contributors are based on amounts of content generated by the contributors using UGC accounts associated with the topic; and
wherein the credibility scores of the contributors are based on feedback from consumers related to the contributors.

2. The method of claim 1, further comprising: providing, by the computing device, a topic selection interface that enables the consumer to select the topic.

3. The method of claim 1,
wherein the contributors include a given contributor; and
wherein the volume score of the given contributor is based on a difference between a frequency at which the given contributor generates content and an optimal frequency parameter, the optimal frequency parameter indicating an amount of content that consumers likely want to receive.

4. The method of claim 1,
wherein the contributors include a given contributor who has claimed a plurality of UGC accounts; and
wherein the credibility of the given contributor is based at least in part on a number of comments by consumers on content generated by the given contributor.

5. The method of claim 1,
Wherein the contributors include a given contributor who has claimed a plurality of UGC accounts; and
Wherein the credibility of the given contributor is based at least in part on a consumer rating of the contributor.

6. The method of claim 1, further comprising: notifying the contributors that the contributors are required to pay a fee in order to claim more than a given number of UGC accounts.

7. The method of claim 1, wherein the user interface comprises a chart, the chart having a credibility axis and a volume axis, the chart containing contributor icons that are associated with ones of the contributors, the contributor icons positioned within the chart based on the volume scores of the contributors and the credibility scores of the contributors.

8. The method of claim 7, wherein the contributor icons include a given contributor icon that is associated with a given contributor, the given contributor icon having a trend indicator that indicates whether the volume score of the given contributor has been increasing or decreasing and whether the credibility score of the given contributor has been increasing or decreasing.

9. The method of claim 7,
wherein the contributor icons include a given contributor icon that is associated with a given contributor; and
wherein the method further comprises:
receiving, by the computing device, input indicating a selection of the given contributor icon; and
in response to receiving the input, providing, by the computing device, a contributor detail interface to the consumer, the contributor detail interface comprising information about the given contributor.

10. The method of claim 1, wherein the user interface comprises one or more controls that enable the consumer to subscribe to content generated by the contributors.

11. The method of claim 1, wherein the contributors generate and distribute the user-generated content using one or more UGC services that are not provided by an entity that provides the social rank service.

12. The method of claim 11, wherein the one or more UGC services include: a microblogging service, a blog, and a social networking service.

13. The method of claim 1, further comprising calculating, by the computing system, the social ranks of the contributors by:
applying a set of scoring rules to the UGC accounts claimed by the contributors to calculate rule scores for the contributors;
totaling the rule scores for each of the contributors to calculate social scores for the contributors; and
comparing the social scores for the contributors to determine the social ranks of the contributors.

14. A computing system comprising:
a processing system; and
one or more computer storage media that store computer-executable instructions that, when executed by the processing system, cause the computing system to send data representing a user interface to a client device used by a consumer, the user interface enabling the consumer compare social ranks of contributors who generate and distribute user-generated content (UGC) regarding a topic,
wherein the social ranks of the contributors with regard to the topic are based on volume scores of the contributors and credibility scores of the contributors,
wherein the volume scores of the contributors are based on amounts of content generated by the contributors using UGC accounts associated with the topic; and
wherein the credibility scores of the contributors are based on feedback from consumers related to the contributors.

15. The computing system of claim 14, wherein the data storage system also comprises computer-executable instructions that, when executed by the processing system, cause the computing system to send data representing a topic selection interface to the client device, the topic selection interface enabling the consumer to select the topic from among a plurality of topics.

16. The computing system of claim 14, wherein the credibility scores of the contributors are based on the number of people who consume content from the contributors.

17. The computing system of claim 14,
wherein the contributors include a given contributor; and
wherein the volume score of the given contributor is based on a difference between a frequency at which the given contributor generates content and an optimal frequency parameter, the optimal frequency parameter indicating an amount of content that consumers likely want to receive.

18. The computing system of claim 13, wherein the user interface comprises a chart, the chart having a credibility axis and a volume axis, the chart comprising contributor icons that are associated with ones of the contributors, the contributor icons positioned within the chart based on the volume scores of the contributors and the credibility scores of the contributors.

19. The computing system of claim 18, wherein the contributor icons include a given contributor icon that is associated with a given contributor, the given contributor icon having a trend indicator that indicates whether the volume score of the given contributor has been increasing or decreasing and whether the credibility score of the given contributor has been increasing or decreasing.

20. The computing system of claim 19, wherein the user interface comprises one or more controls that enable the consumer to subscribe to content generated by one of the contributors.

21. A computer-readable data storage medium that stores computer-executable instructions that, when executed by a computing device, cause the computing device to:
display a user interface that enables a user of the computing device to compare social ranks of contributors who generate and distribute user-generated content (UGC) regarding a topic,
wherein the social ranks of the contributors with regard to the topic are based on volume scores of the contributors and credibility scores of the contributors,
wherein the volume scores of the contributors are based on amounts of content generated by the contributors using UGC accounts associated with the topic; and
wherein the credibility scores of the contributors are based feedback from consumers related to the contributors.
